(19) United States
(12) Patent Application Publication
(10) Pub. No.: US 2016/0074884 A1
(43) Pub. Date: Mar. 17, 2016

(54) DUAL RAIN SHOWER SYSTEM

(71) Applicant: W. Spilman Short, Richmond, VA (US)

(72) Inventor: W. Spilman Short, Richmond, VA (US)

(21) Appl. No.: 14/948,785

(22) Filed: Nov. 23, 2015

Related U.S. Application Data
(63) Continuation-in-part of application No. 12/932,645, filed on Mar. 2, 2011, now abandoned.

(51) Int. Cl. B05B 1/18; E03C 1/02; B05B 1/20

(52) U.S. Cl. CPC B05B 1/185; B05B 1/20; E03C 1/025

(57) ABSTRACT

A dual shower system that enables installation or conversion of a single showerhead system to a two-showerhead system in which a user can direct flow to a selected one of the two showerheads or to both showerheads as desired. The dual rain shower system includes a first supply line for connecting to an existing water supply, a three-way diverter valve, a second supply line including a tee, a distal end connector, and a first and second showerhead. The showerheads include a water-dispersing plate with a plurality of nozzles therein. A ball and socket arrangement on the showerheads enables adjustment of the water-dispersing plate to a horizontal orientation or to various angles with respect to the supply lines. The first supply line may be a horizontal or an elevated supply line in order to adjust the height of the dual shower system.

This application is a Continuation-In-Part of U.S. patent application Ser. No. 12/932,645, filed Mar. 2, 2011 and still pending, the contents of which are incorporated herein by reference.

### FIELD OF INVENTION

The present invention relates to a dual rain shower system and in particular to a system including two showerheads and a three-way diverter valve for providing rain like delivery of water to one or both showerheads.

### BACKGROUND OF INVENTION

The use of dual showerheads enabling two individuals to shower independently at the same in a shower enclosure or shower recess has been disclosed in U.S. Pat. Nos. 3,822,826 (the '826 Patent) and 3,913,839 (the '839 Patent) to Wilson. The showers of the '826 and '839 Patents are designed for conventional showering and conventional water dispensing to the showering individual. The '826 patent discloses a single control valve in the path of flow to the showerheads for controlling the flow of water to both showerheads. The '839 Patent discloses a dual showerhead system wherein the flow of water can be adjusted by a control valve in each showerhead.

U.S. Pat. No. 5,564,139 (the '139 Patent) to Shorr discloses a dual shower assembly having individual cut off valves in each showerhead. The dual showerhead of the '139 Patent is particularly designed for providing for water from two sides to a single showering individual.

Although various dual shower assemblies have been proposed, there are limited in their ease of installation for the installer, their ability to adjust the direction of flow, their lack of an ability to indicate direction of flow, and their ability to adjust the height of the showering apparatus.

### SUMMARY OF THE INVENTION

The invention is a dual shower system that enables installation or conversion of a single showerhead system to a two-showerhead system in which a user can direct flow to a selected one of the two showerheads or to both showerheads as desired. The dual rain shower system includes a first supply line for connecting to an existing water supply, a three-way diverter valve, a second supply line including a tee, a distal end connector, and a first and second showerhead. The showerheads include a water-dispersing plate with a plurality of nozzles therein. A ball and socket arrangement on the showerheads enables a user to adjust the water-dispersing plate to a horizontal orientation or to various angles with respect to the supply lines. The first supply line may be a horizontal or an elevated supply line in order to adjust the height of the dual shower system. The three-way diverter valve includes a rotatable adjustment knob and a flow indicator tab to indicate direction of flow. The shower system includes an escutcheon plate including two pivotally interconnected wings for covering an end of the first supply line and a distal end connector for securing an end of the second supply line to the shower wall enclosure. The dual rain shower apparatus may further comprise a slidably adjustable tubular extender for adjusting the length of the shower system within a shower enclosure.

### DESCRIPTION OF THE DRAWINGS

FIG. 1 shows a front view of a first embodiment of an installed dual rain shower assembly of the invention.

FIG. 2 shows an expanded sectional view of an embodiment of the invention having a supply line extender apparatus.

FIG. 3 shows a view of two adults using the dual rain shower system of the invention including showing water dispersion from the rain showerheads.

FIG. 4 shows a view of the water dispersing plate of a rain showerhead as viewed looking upward form the shower floor.

FIG. 5 is an exploded side view of a second embodiment of a dual rain shower assembly according to the present invention.

FIG. 6 is an exploded side view of a third embodiment of a dual rain shower assembly according to the present invention.

FIG. 7 is a side view of a horizontal extender that forms a portion of the dual rain shower assembly of FIG. 5.

FIG. 8 is a side view of an elevation extender that forms a portion of the dual rain shower assembly of FIG. 6.

FIG. 9 is a side view of a distal end connector that forms a portion of the dual rain shower assembly of FIG. 5.

FIG. 10 is a front elevation view of the distal end connector, as viewed from the left side of FIG. 9.

FIG. 11 is a side view of a showerhead that forms a portion of the dual rain shower assembly of FIG. 5.

FIG. 11A is a sectional view of an inlet portion of the showerhead taken along line 11A-11A of FIG. 11.

FIG. 12 shows a view of the water dispersing plate of a rain showerhead as viewed looking upward form the shower floor.

FIG. 12A is a sectional view of the water-dispersing plate of the showerhead taken along line 12A-12A of FIG. 12.

FIG. 13 is a front elevation view of an escutcheon plate that forms a portion of the dual rain shower assembly of FIG. 5.

FIG. 14 is a sectional view of the escutcheon plate taken along lines 14-14 of FIG. 13.

FIG. 15 is a rear elevation view of the escutcheon plate pivoted to an open position.

FIG. 16 is a front elevation view of the escutcheon plate pivoted to a closed position.

FIG. 17 is a front view of a three-way valve that forms a portion of the dual rain shower assembly of FIG. 5.

FIG. 18 is a left side view of the three-way valve.

FIG. 19 is a right side view of the three-way valve.

FIG. 20 is a bottom view of the three-way valve.

FIG. 21 is a front view of the three-way valve depicting a first flow path for the valve.

FIG. 22 is a front view of the three-way valve depicting a second flow path for the valve.

FIG. 23 is a front view of the three-way valve depicting a third flow path for the valve.

FIG. 24 is a sectional view of the three-way valve taken along line 24-24 of FIG. 19

### DETAILED DESCRIPTION OF THE INVENTION

The present invention provides a dual rain shower system. The present system provides for a gentle rain like delivery of water to two individuals simultaneously and accordingly provides a spa like experience in addition to bathing.

The dual rain shower system employs two rain showerheads. A rain showerhead is a showerhead that delivers water in a soft, gentle, but thorough spray that simulates the experience of being in a gentle rain. Typically, in contrast to conventional showerheads, the rain showerhead has a flat plate surface with multiple apertures spaced apart through which water is dispensed. Exemplary typical commercial embodiments of rain showerheads have a plate flat surface that is about 7 inches to about 12 inches in diameter if circular in configuration and about 7 inches to about 12 inches across if square or rectangular in configuration. The rain showerhead is positioned in a shower stall such that the flat plate surface is parallel to the shower stall floor and is above the head of the individual using the shower to facilitate the rain like experience for the user. Additionally, as the water dispersion surface of the rain showerhead is substantially greater than the water dispersion surface of a conventional showerhead, single rain showerheads have been used in shower installations. The Kohler K-8030 showerhead made by Kohler (Kohler Co., 444 Highland Dr., Kohler, Wis. 53044) is exemplary of a commercially available rain showerhead.

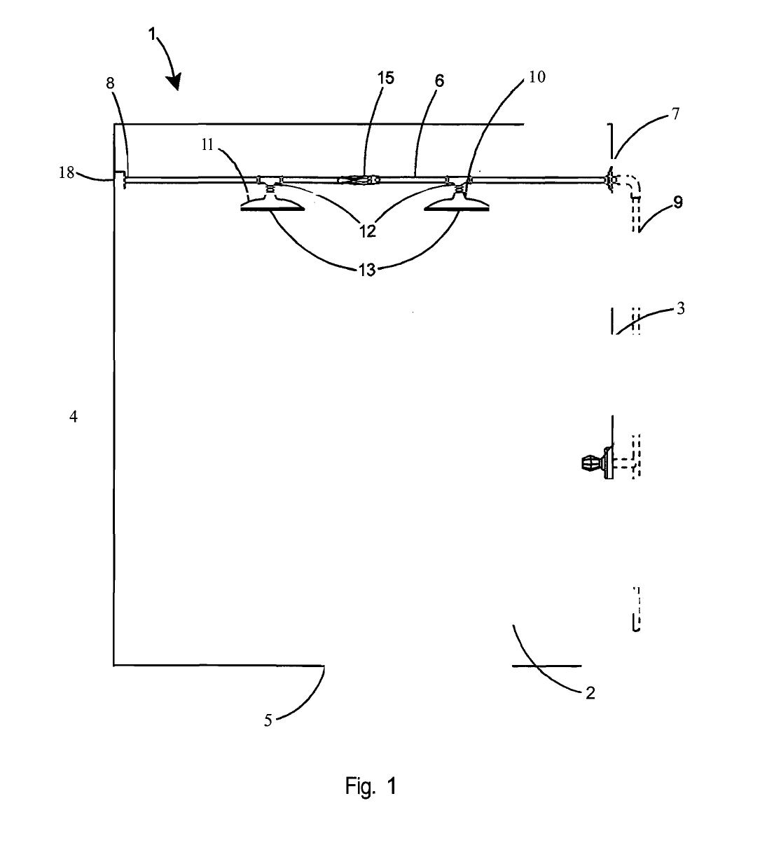

FIG. 1 shows a first embodiment of the dual rain shower system of the invention. The dual rain shower assembly 1 is positioned in a shower enclosure 2. The shower enclosure 2 has a first wall 3, a second wall 4 and a floor 5.

A horizontal supply line 6 is positioned between the first wall 3 and second wall 4 and is parallel to the floor 5. The supply line 6 is fixed securely into position. The supply line 6 has a proximal end 7 and a distal end 8. The proximal and distal ends 7, 8 are secured to the first 3 and second 4 wall, respectively. The proximal end 7 is connected to a pressurize water source 9 via a connection that permits the flow of water from the pressurized water source 9 into the supply line 6. The direction of flow of water though the supply line 6 is from the proximal end 7 toward the distal end 8. The flow of water may be regulated from the pressurized water source 9 utilizing a conventional water control faucet in communication with the pressurized water source 9. The distal end 8 of the supply line 6 is closed such that pressurized water cannot flow from the distal end 8 of the water supply line 6.

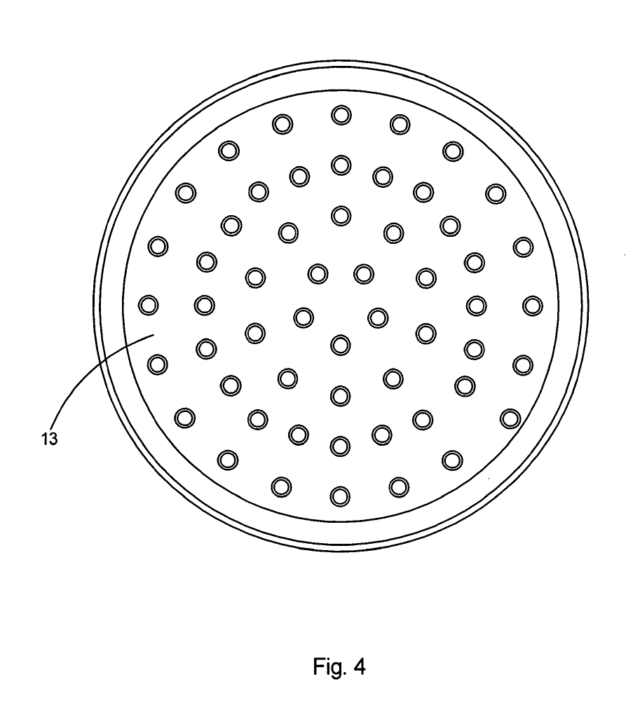

A first and a second rain showerhead 10, 11 are connected to the supply line 6. Each rain showerhead 10, 11 has a connector 124 and a water dispersing plate 13. Each connector 12 is secured to the supply line 6 between the proximal and the distal ends 7,8 with the water dispersing plates 13 extending downward from and pointed straight downward from the supply line 6 such that the water each dispersing plate 13 is substantially parallel to the floor 5. FIG. 4 shows the water dispersing plate as it would appear looking upward from the shower floor 5.

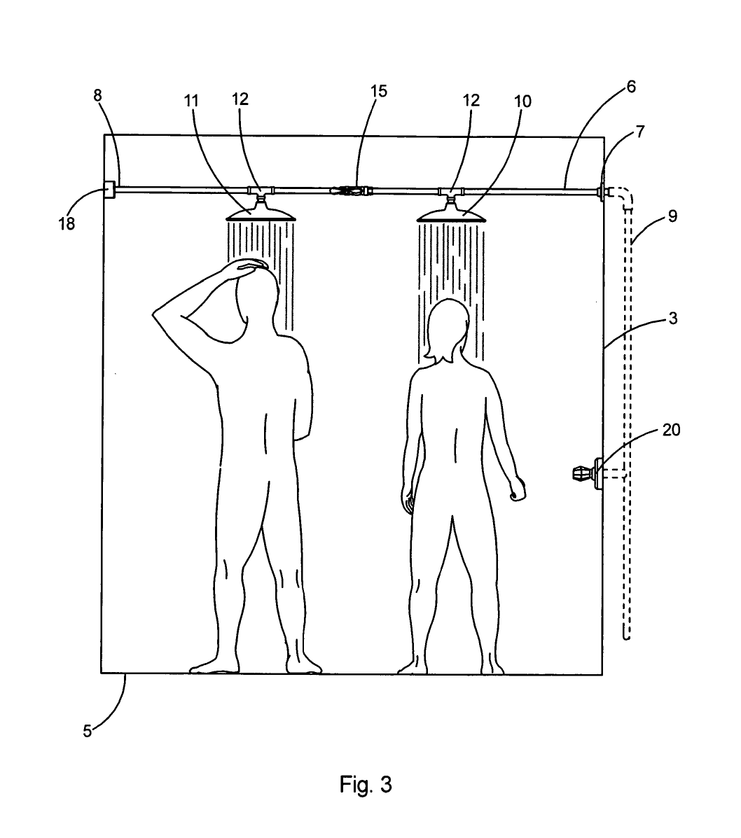

Referring again to FIG. 1, in one exemplary embodiment, the connectors 12 are open threaded, universal receptacles. The supply line 6 and connectors 12 provide for simultaneous distribution of pressurized water to both the first and second rain showerheads 10, 11. As shown in FIG. 3, the rain showerheads 10, 11 are preferably fixed in a position on the supply line 6 sufficiently apart as to permit the simultaneous use of the rain showerheads 10, 11 by two adult individuals. In one exemplary embodiment, the connectors 12 of the first and second rain showerheads 10, 11 are positioned at least 18 inches and more preferably at least about 24 inches apart on the supply line. The connectors 12 are attached to the supply line 6 so as to allow the flow of water from the supply line 6 into the rain showerheads 10, 11. As the direction of flow of water in supply line 6 is from the proximal end 7 to the distal end 8, the first rain showerhead 10 would be an upstream showerhead and the second rain showerhead 11 would be a downstream showerhead with regard to the flow of water. The supply line 6 and the rain showerheads 10, 11 are positioned at a vertical height from the floor 5 such that the water dispersing plates 13 of the rain showerheads 10, 11 are above the head of an individual using the shower. This permits flow of water over the entire body like a gentle rain. In one exemplary embodiment, the distance between the water dispersing plates 13 of the shower heads 10, 11 is at least about 72 inches above the floor 5. The optimum distance between the water dispersing plate 13 and the floor 5 may be determined by the height of the potential users as the water dispersing plate 13 should be above the head of the user. Referring again to FIG. 1 a cut off valve 15 is positioned in the supply line 6 between the connectors 12 of the first and the second rain showerhead 10, 11. The cut off valve 15 may be positioned at any point between the rain showerheads 10, 11 and should permit blocking the flow of water from the first rain showerhead 10 to second rain showerhead 11 without impacting the operation (e.g. flow of water) to the first rain showerhead 10. The cutoff valve permits optional conservation of water when the shower is used by a single individual by providing for turning the second or downstream rain showerhead 11 off when one person is using the first or upstream rain showerhead 10. Exemplary suitable cutoff valves include, but are not limited to, ball valves and lever valves.

As indicated above the distal end 8 of the supply line 6 is closed such that pressurized water cannot flow from the distal end 8 of the water supply line 6. In one exemplary embodiment, this is accomplished by threading the distal end 8 of the supply line and attaching a cap with threading that can be secured into place by twisting the cap onto the threaded distal end of the supply line.

Alternatively, in one embodiment, the supply line 6 may include a hollow center portion and a solid center portion. The hollow center portion of the supply line 6 extends from the proximal end 7 to at least to the connector 12 of the second rain showerhead 11. “To the second connecter” means that the hollow portion extends to the attachment of the connector and provides a channel to permit of water flow from the proximal end 7 of the supply line 6 to and through the second rain showerhead 11. The optional solid portion extends at least a portion of the way between the second showerhead 11 and the distal end 8 of the supply line 6. The solid center portion prevents flow of water. This optional solid center portion not only prevents the flow of water to between the second rain showerhead 11 and the distal end 8 of the supply line 6, but also may facilitate the installation of the dual rain shower system by permitting the installer to adjust the length of the line to fit the shower enclosure 2 simply by cutting across the supply line 6 in the portion having the solid center, thus eliminating the need for additional cut off fittings or plugs to prevent water flowing from the distal end 8 of the supply line 6.

The distal end 8 of the supply line is attached to the second wall 4 by means of a fastening arrangement 18. Exemplary fastening arrangements 18 include, but are not limited to, a wall mount bracket and an escutcheon plate.

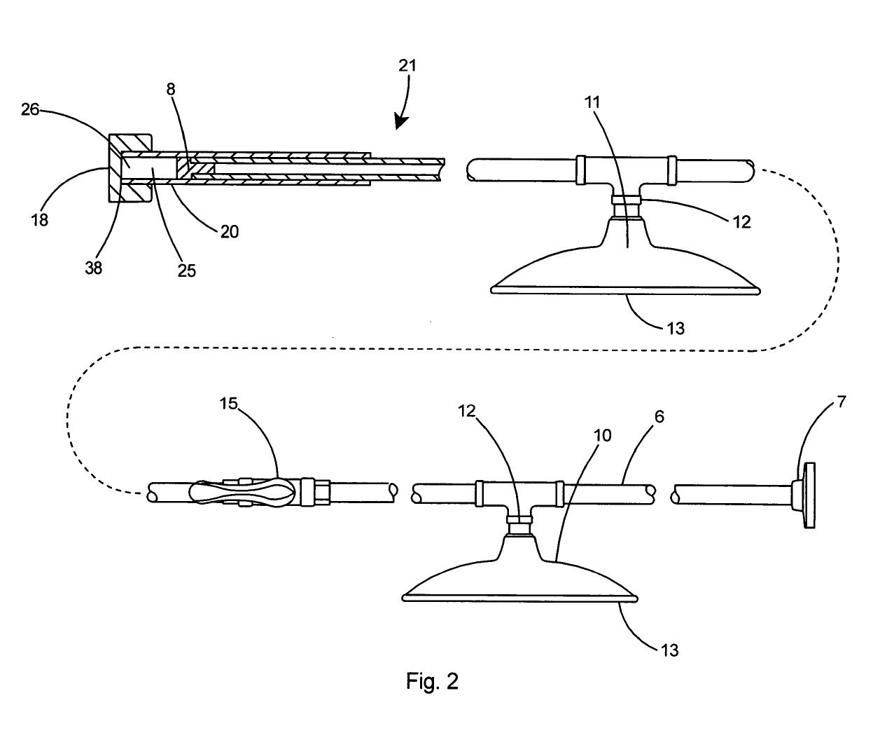

One exemplary embodiment of the dual rain shower apparatus of the invention further includes a slidably adjustable tubular extender. Referring to FIG. 2, the slidably adjustable tubular extender 20 is a hollow tube having a central cavity 25 and a terminal end 26. The diameter of the central cavity 25 is such that the distal end 8 of the supply line 6 will slide in the central cavity 25 in slidable communication with the slidably adjustable tubular extender 20. Slidable communication is taken to mean movable with a sliding or twisting motion, but with sufficient contact between the contacting surfaces to prevent flow of water between the contacting surfaces. The slidably adjustable tubular extender 20 should be slidable along at least a portion of the distance along the supply line 6 between the connector 12 of the second rain showerhead 11 and the distal end 8 of the supply line 6.

Optionally, the slidably adjustable tubular extender 20 may be longer than the length of the supply line connector 12 of second rain showerhead 11 and the distal end of the supply line 6.

The slidably adjustable tubular extender 20, the supply line 6 the connectors 12 and the first and the second rain showerheads 10, 11 comprise the supply line extender apparatus 21. In this embodiment the terminal end 26 of the slidably adjustable tubular extender 20 forms the distal end 38 of the supply line extender apparatus 21. The length of supply extender apparatus 21 can be adjusted to customize the supply extender apparatus 21 length to fit an individual specific shower stall or shower recess. The length of the supply extender apparatus 21 is adjusted by adjusting the position of the slidably adjustable tubular extender 20 on the supply line 6. The position of the slidably adjustable tubular extender 20 on the supply line 6 may be adjusted in a telescoping manner. This may be accomplished for, example, by moving the slidably adjustable tubular extender 20 in a motion parallel to the supply line 6 or alternatively, by twisting the slidably adjustable tubular extender 20 along the supply line 6.

In one embodiment having a supply line extender apparatus 21, the distal end of the 38 of the supply line extender apparatus 21 is attached to the second wall 4 by means of a fastening arrangement 18. Exemplary fastening arrangements 18 include, but are not limited to, a wall mount bracket and an escutcheon plate.

Optionally, the proximal end 7 of the supply line 6 is pre-threaded to facilitate connection of the supply line to the pressurized water source 9.

The invention further includes a kit for a dual rain shower apparatus. The kit comprises a horizontal supply line, which has a threaded proximal end, a distal end, a hollow center portion and a solid center portion; and a first and a second rain showerhead, each rain showerhead having a connector and a water dispersing plate with the connector secured to the supply line between the proximate and the distal ends of the supply line and the water dispersing plate extending downward from the supply line; and a slidably adjustable tubular extender, said slidably adjustable tubular extender positioned in slidable communication with at least a portion of the supply line between the distal end of the supply line and the second rain showerhead and having a terminal end extending beyond the end of the distal end of the supply line. The kit further includes a cut off valve positioned in the supply line between the first and the second rain showerhead connectors and a fastening arrangement abutting the terminal end of the slidably adjustable tubular extender. Exemplary fastening arrangements 18 include, but are not limited to, a wall mount bracket and an escutcheon plate.

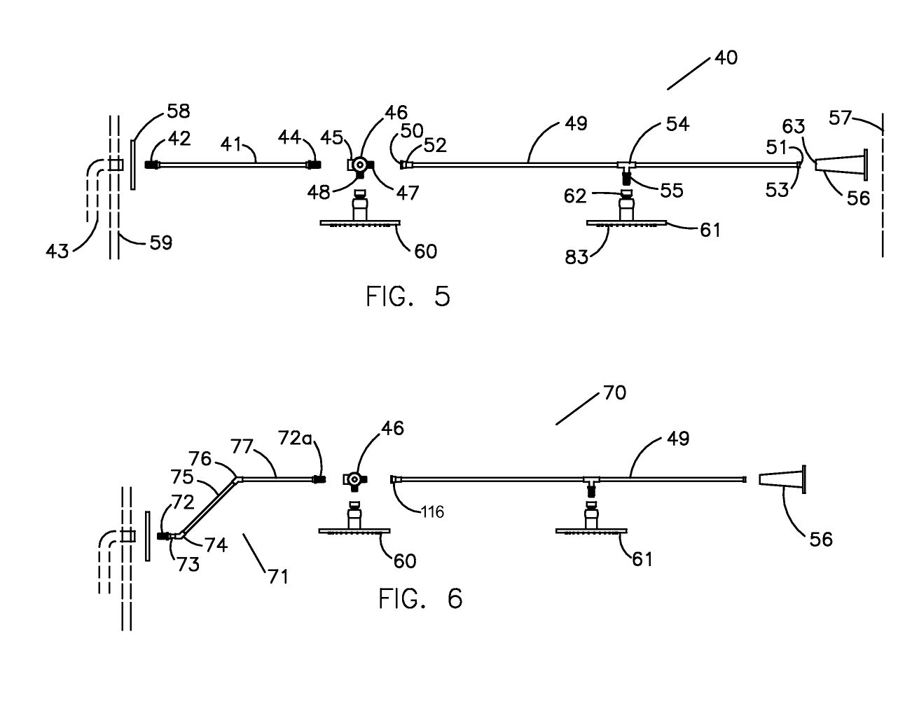

Referring to FIG. 5, the second and preferred embodiment of a dual rain shower assembly 40 according to the present invention includes a tubular horizontal supply line 41 having an externally threaded proximal end 42 for connection to an existing water supply 43. The horizontal supply line 41 further includes a threaded distal end 44 for connection to the internally threaded supply socket 45 of a three-way diverter valve 46. Three-way diverter valve 46 further includes a first externally threaded output port 47 and a second externally threaded output port 48. The dual rain shower assembly 40 further includes a second tubular supply line 49 including a proximal end 50 and a distal end 51. Proximal end 50 of second supply line 49 includes an internally threaded socket 52 and distal end 51 of second supply line 49 includes an end cap 53. A tee 54 having an externally threaded output port 55 is affixed to the second supply line 49 at a point between the proximal end 50 and distal end 51. A distal end connector 56 facilitates anchoring of the distal end of the second supply line 49 to a distal wall 57 of a shower enclosure. An escutcheon plate 58 is used to cover the connection point of the horizontal supply line 41 to the proximal wall 59 of the shower enclosure. A first rain showerhead 60 is connectable to the second externally threaded output port 48 of the three-way diverter valve 46 and a second rain showerhead 61 is connectable to the externally threaded output port 55 of the tee 54. Rain showerheads 60 and 61 each include an internally threaded socket 62. To facilitate easy assembly of the dual rain shower assembly 40 of FIG. 5, all of the externally threaded portions of the horizontal supply line 41, the three-way diverter valve 46, the second supply line 49, the tee 54, and the first and second rain showerheads 60 and 61 include complementary threads with the internally threaded supply socket 45 of the three-way diverter valve 46, the internally threaded socket 52 at the proximal end 50 of the second supply line 49, and with the internally threaded sockets 62 of the showerheads 60 and 61. End cap 53 prevents water flow from the distal end 51 of the second supply line 49. For assembly to the shower enclosure, the distal end 51 of second supply line 49 including the end cap 53 are simply fitted into the tubular inlet end 63 of the distal end connector 56 to anchor the distal end 51 to the distal wall 57 of the shower enclosure.

With reference to FIG. 6, a third embodiment of the dual rain shower assembly 70 according to the present invention includes an elevated supply line 71. As shown in FIG. 8, the elevated supply line 71 includes an externally threaded proximal end 72 and an externally threaded distal end 72a. The elevated supply line 71 includes an inlet pipe 73, a first angular connector 74, an elevator pipe 75, a second angular connector 76, and an outlet pipe 77. The elevated supply line 71 may optionally be used in place of the horizontal supply line 41 of the second embodiment (see FIG. 5) in those situations where the shower enclosure requires the dual rain shower assembly to be higher to create proper head clearance for the users of the shower. First and second angular connectors 74 and 75 preferably are of equal angles to align inlet pipe 73 and outlet pipe 77 oriented horizontally. Most preferably, first and second angular connectors 74 and 75 each provide a bend of 45 degrees to the shower flow path.

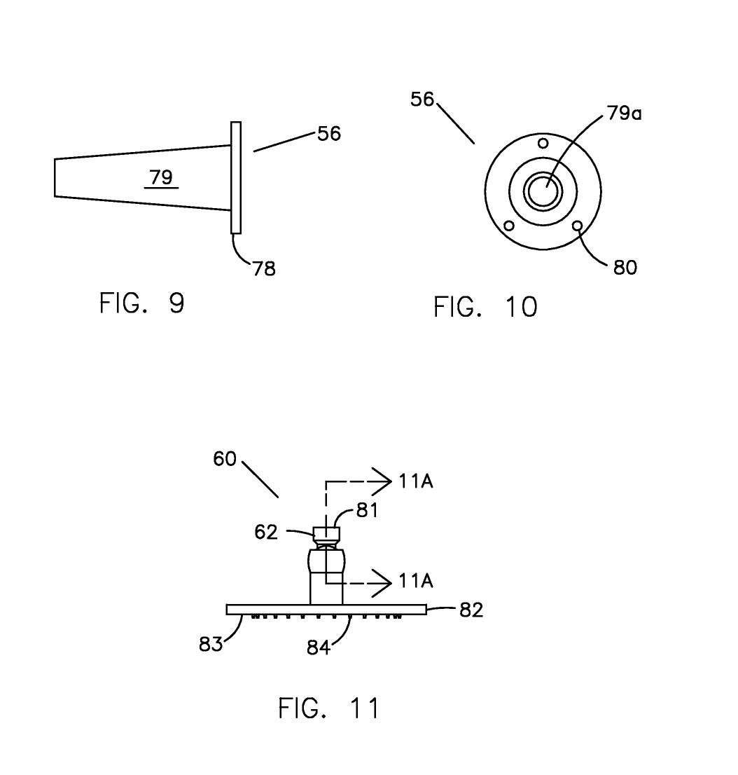

With reference to FIGS. 9 and 10, the distal end connector 56 includes a base plate 78 and a tubular nose cone 79 having an opening 79a there through extending from the base plate. Tubular nose cone 79 of distal end connector 56 includes a substantially long length, preferably 5-inches or more, to facilitate fitting of the dual rain shower assembly to shower enclosures of various lengths. Thus distal end connector 56 acts substantially as an adjustable tubular extender as shown in the first embodiment herein. One or more apertures 80 are provided in the base plate 78 to facilitate connection, by means of fasteners such as screws, to the distal wall 57 of a shower enclosure (see FIG. 5). According to the present invention, the tubular nose cone 79, after being anchored to the distal wall 57 of the shower enclosure, will accept entry of and provide support to the distal end 51 of the second supply line 49 at the distal wall 57 of a shower enclosure and will maintain the dual rain shower supply lines 41 and 49 in a horizontal orientation.

Referring to FIGS. 11-12, according to the present invention a rain showerhead 60 and 61, with showerhead 60 depicted in the figures, includes the internally threaded socket 62 on an inlet end 81. The showerhead includes a water-distribution housing 82 and a water-dispersing plate 83 with a plurality of nozzles 84 therein. The nozzles 84 are arranged in a plurality of successive circular rows 85. Each successive circular row 85 of nozzles 84 decreases in diameter from the outermost row 86 to the innermost row 87 as shown in FIG. 12. A portion of the nozzles 84 extend outward from the water-dispersing plate 83 as shown in FIG. 11. The rain showerhead is preferably constructed of rust-proof metal and the nozzles 84 are preferably constructed of pliable plastic enabling the nozzles 84 to be pressed into apertures in the water-dispersing plate 83. As shown in FIG. 12A, each nozzle 84 includes an inlet end 88, a base flange 89, a conical nose portion 89a, and a circumferential notch 90 extending circumferentially around the nozzle proximate the inlet end 88. A water passageway 91 extends through the nozzle 84 from the inlet end 88 to an outlet end 92. The pliable nozzles 84 are preferably pressed into the apertures 93 until the circumferential notch 90 seats on the water-dispersing plate 83 and the conical nose portion 89a extends from the distribution plate 83.

As shown in FIG. 11A, each rain showerhead 60 and 61 (60 shown) preferably includes a ball and socket arrangement 94 at the inlet end 81. An inlet pipe 95 includes the internally threaded socket 62 at the inlet end 81 and a ball 96 at the outlet end 97. Ball 96 is press-fitted and held within a corresponding socket 98 on the tubular inlet 99 of the rain showerhead. The ball and socket arrangement 94 enables rotation of the rain showerhead with respect to the tubular inlet 99 to allow a user to adjust the water-dispersing plate 83 to a horizontal orientation or to various angles with respect to the horizontal supply lines. The pressure fit of ball 96 within socket 98 enables the water-dispersing plate 83 to remain in the set orientation until subsequently readjusted by the user.

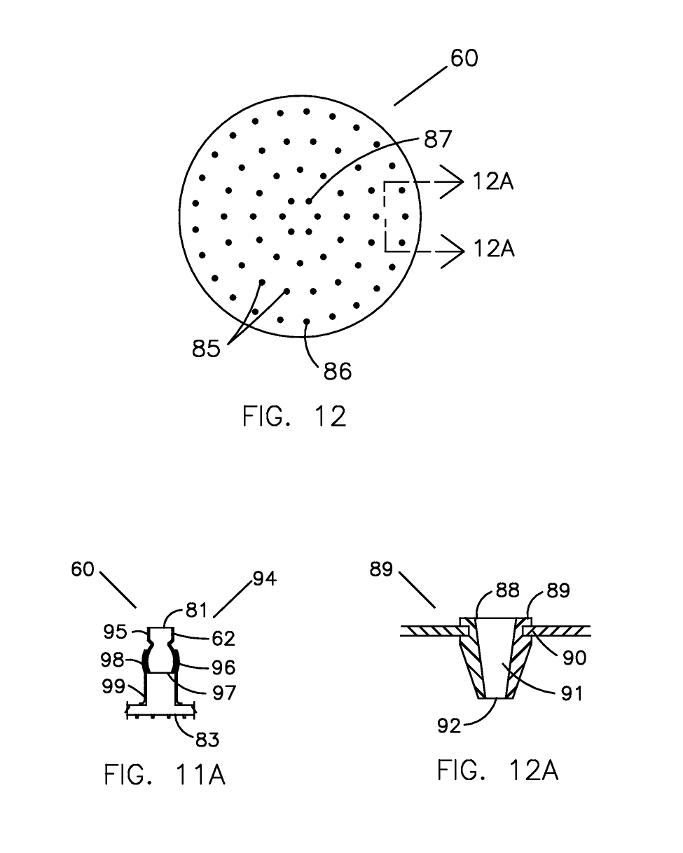

With reference to FIGS. 13-16, the escutcheon plate 58 include two wings 100 held together around a pivot point 101 by a rivet 102 or similar fastener that allows rotation of one wing with respect to the opposing wing. Each wing 100 includes a planar plate portion 103, a planar edge 104, and a semicircular notch 105 extending between the planar edges. An inner raised periphery 106 extends from the back side 107 of the plate 103 around the semicircular notch 105 and an outer raised periphery 108 extends from the back side 107 of the plate 103 around the outer periphery of each wing 100. As shown in FIG. 15, a first wing 100A includes an upturned circular edge 109 extending from the back side 107 of the plate 103 and the second wing 100B includes a complementary aperture 110 therein. Escutcheon plate 58 provides a convenient means of covering the entry point of the supply line after it is connected to the existing water supply. To install the escutcheon plate 58 around the proximal end of the supply line at the proximal wall 59 (see FIG. 5) of the shower enclosure, first wing 100A and second wing 100B are pulled in opposite directions to spread them apart at the pivot point 101. After being installed around the supply line, the wings 100A and 100B are pressed together whereupon upturned circular edge 109 on first wing 100A snaps into the complementary aperture 110 on second wing 100B and locks the escutcheon plate around the supply line and against the proximal wall 59 of the shower enclosure.

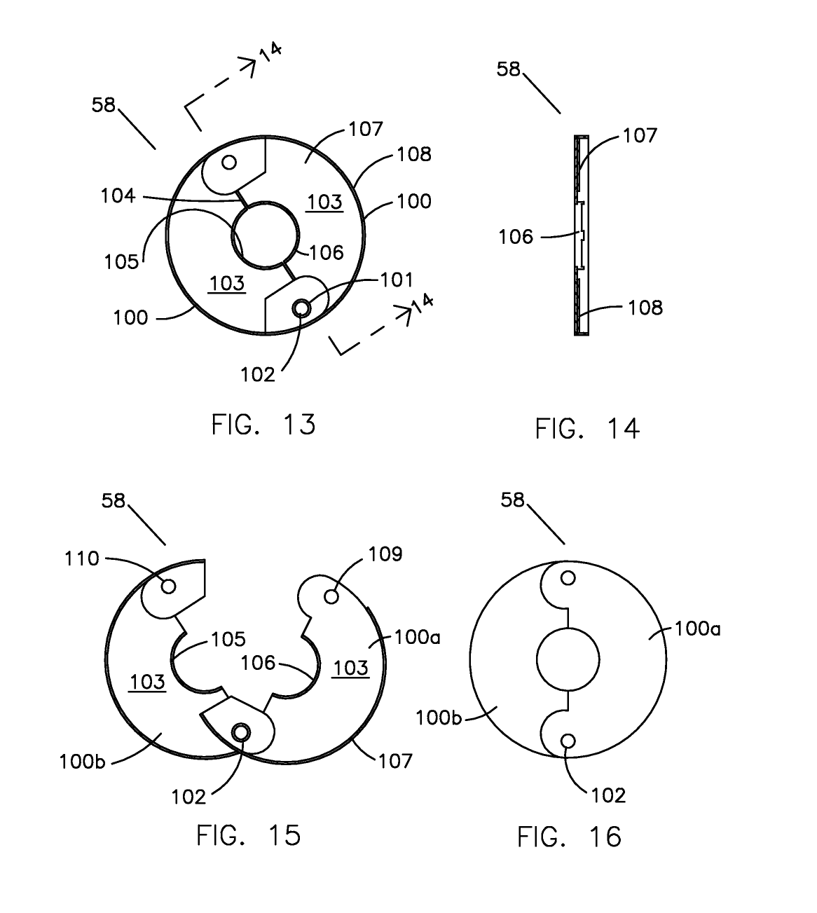

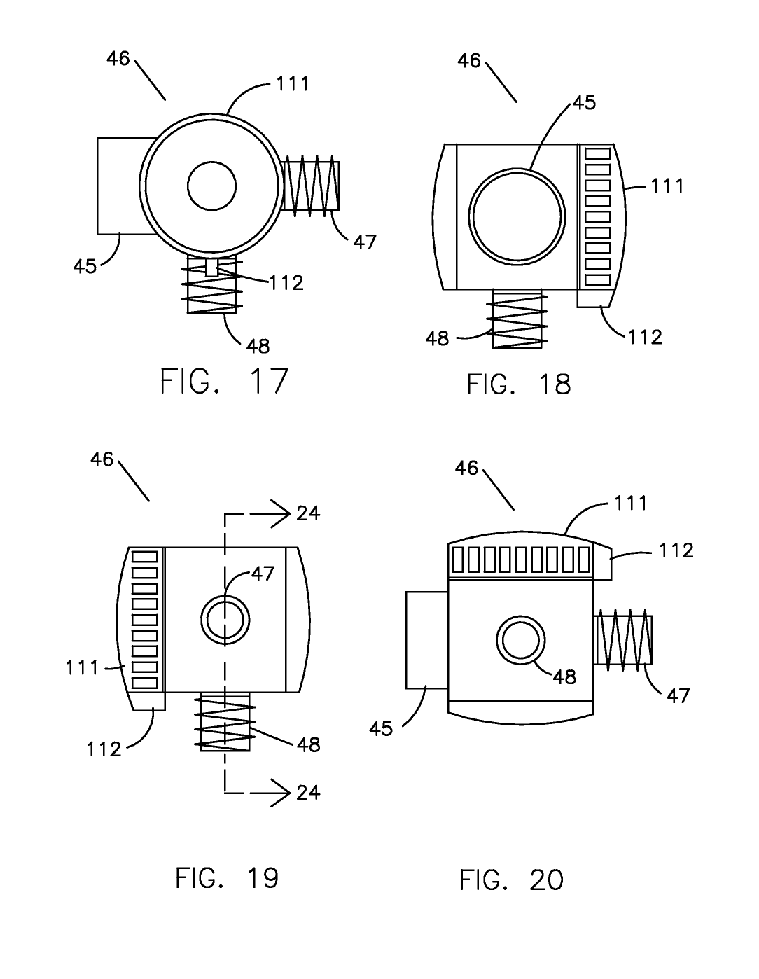

Referring to FIGS. 17-20, the three-way diverter valve 46 includes an internally threaded supply socket 45, a first externally threaded output port 47, and a second externally threaded output port 48. Threaded socket 45 and threaded output ports 47 and 48 facilitate easy and rapid attachment of the supply lines of the dual rain shower assembly. The three-way diverter valve 46 includes a rotatable adjustment knob 111 with a flow indicator tab 112 thereon.

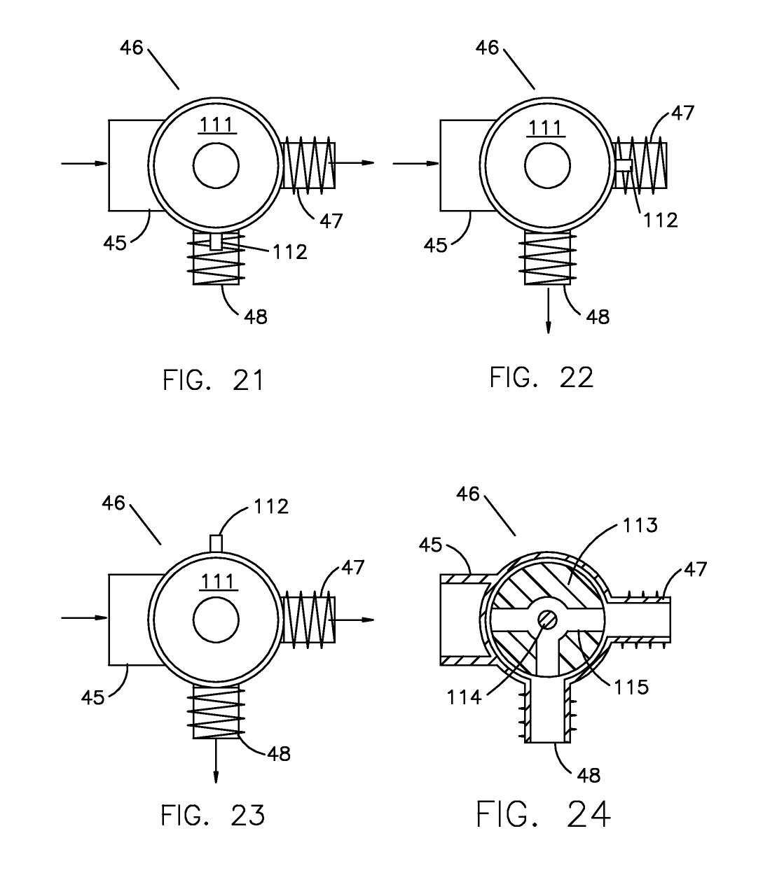

FIGS. 21-24 illustrate the operation of the three-way diverter valve 46. Essentially, when the flow indicator tab 112 is aligned with one of the output ports, the water flow is blocked to that output port. Thus, when the adjustment knob 111 is rotated so that the indicator tab 112 is pointed down, as shown in FIG. 21, water flow is blocked to the second output port 48 and flow is open to the first output port 47. With the adjustment knob 111 rotated so that the indicator tab 112 is pointed to the right, as shown in FIG. 22, water flow is blocked to the first output port 47 and flow is open to the second output port 48. With the adjustment knob 111 rotated so that the indicator tab 112 is pointed up, as shown in FIG. 23, water flow is open to both the first output port 47 to the second output port 48. Three-way diverter valve 46 is a an internally spring-loaded valve thus enabling the adjustment knob 111 to snap into position from one tab orientation to another as it is turned. As shown in FIG. 24, the three-way diverter valve 46 includes an internal ball 113 including a center pivot 114 and a three-way passage 115 therein. Rotation of the adjustment knob 111 to the various tab positions will enable turning on flow to either only the downstream showerhead, the upstream showerhead, or to both showerheads as desired by the operator.

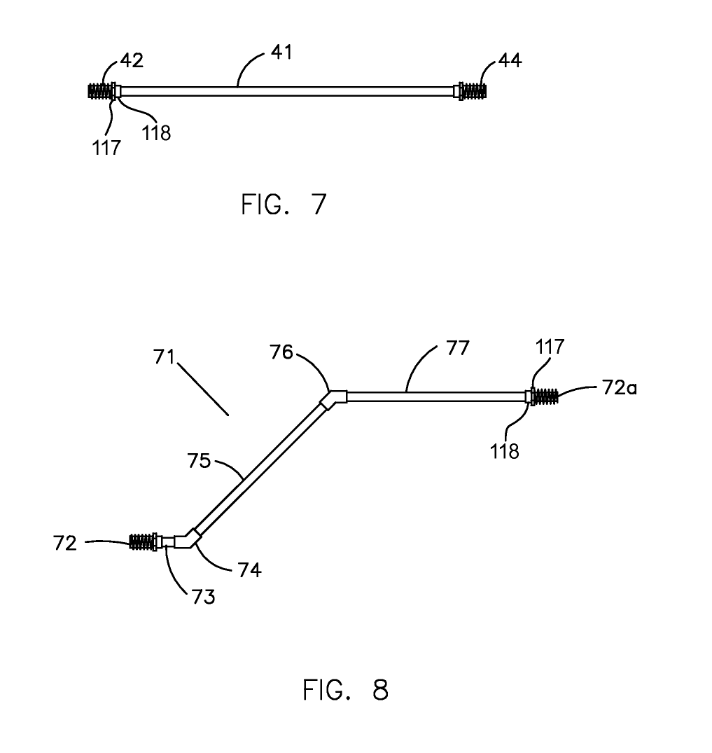

As shown in FIG. 6, second supply line 49 includes an internally threaded socket 116 to facilitate easy connection of second supply line to three-way diverter valve 46. Furthermore, as shown in FIGS. 6-8, first horizontal line 41, elevated supply line 71, and second supply line 49 include a collar 117 adjacent their respective threaded ends and a hex surface 118 adjacent the collar. The collar 117 is wider than the threads and stops travel of threaded ends within the line they are connecting to. Hex surface 118 includes opposing flats thereon to facilitate easy grasping with an open end wrench to tighten the supply lines to the existing piping and to the three-way diverter valve 46.

With reference to FIGS. 5 and 6, after determining whether the horizontal supply line 41 or the elevated supply line 71 is correct for the conversion of the existing shower enclosure, the dual rain shower assembly is operated by 1) screwing the proximal end 42 of the first supply line 41 or 71 into the existing water supply 43; 2) screwing the internally threaded socket 45 of the three-way diverter valve 46 onto the first supply line 41 or 71; 3) sliding the tubular nose cone 79 of the distal end connector 56 onto the distal end 51 of the second supply line 49; 4) screwing the second supply line 49 onto the first output port 47 of the three-way diverter valve 46; 5) attaching the distal end connector 56 to the distal shower enclosure wall 57 with fasteners; 6) screwing a first showerhead 60 to the second output port 48 of the three-way diverter valve 46; 7) screwing a second showerhead 62 to the output port 55 of tee 54; 8) opening the two wings 100 of the escutcheon plate 58; and 9) closing the two wings 100 of the escutcheon plate 58 until the two wings snap lock together around the first supply line 41 or 71.

All of the components of the dual rain shower assembly, including the fasteners for use with the distal end connector 56 and a roll of TEFLON® tape, are included with the assembly. A homeowner may thus convert a conventional shower enclosure to the dual rain shower assembly with a minimal of effort and time using simple tools, such as a small drill, a screwdriver, and a pair of pliers.

What is at present considered the preferred embodiment and alternative embodiments of the present invention has been shown and described herein. It will be obvious to those skilled in the art that various changes and modifications may be made therein without departing from the scope of the invention as defined by the appended claims.

What is claimed is:

1. A shower assembly comprising:
a first supply line for connection to an existing water supply;
a three-way diverter valve for connection to the first supply line;
a second supply line including a tee;
a distal end connector;
a first showerhead for connection to said three-way diverter valve and a second showerhead for connection to said tee; and
a ball and socket arrangement on said first and second showerheads.

2. The shower assembly of claim 1 including
an inlet end on said first and second showerheads; and
said ball and socket arrangement is on said inlet end of said first and second showerheads.

3. The shower assembly of claim 1 wherein said first supply line includes
a horizontal supply line; and
an elevated supply line.

4. The shower assembly of claim 3 wherein said horizontal supply line includes a straight tubular body and two externally threaded ends.

5. The shower assembly of claim 3 wherein said elevated supply line includes
an inlet pipe;
an elevator pipe; and
an outlet pipe.

6. The shower assembly of claim 4 wherein said elevated supply line includes
a first angular connector;
a second angular connector; and
two externally threaded ends.

7. The shower assembly of claim 1 wherein said showerheads include
a water-distribution housing; and
a water-dispersing plate.

8. The shower assembly of claim 7 including a nozzle in said distribution plate of said showerhead.

9. The shower assembly of claim 1 wherein said three-way diverter valve includes
an internally threaded supply socket;
a first externally threaded output port; and
a second externally threaded output port.

10. The shower assembly of claim 9 further comprising a rotatable adjustment knob on said three-way diverter valve.

11. The shower assembly of claim 10 further comprising a flow indicator tab on said rotatable adjustment knob.

12. The shower assembly of claim 8 further comprising:
a base flange on said nozzle; and
a circumferential notch extending circumferentially around said nozzle.

13. The shower assembly of claim 12 further comprising:
a conical nose portion on said nozzle; and
said conical nose portion extending from said distribution plate of said showerhead.

14. The shower assembly of claim 1 wherein said ball and socket arrangement includes
a tubular inlet on said showerheads;
a socket on said tubular inlet; and
a ball press-fitted and held within said socket on said tubular inlet of said showerhead.

15. The shower assembly of claim 1 further comprising a base plate and a tubular nose cone on said distal end connector.

16. The shower assembly of claim 1 further comprising an opening extending through said base plate and said nose cone of said distal end connector.

17. The shower assembly of claim 1 further comprising:
a proximate end on said first supply line; and
an escutcheon plate for covering the proximate end of said first supply line.

18. The shower assembly of claim 17 further comprising:
two pivotally interconnected wings on said escutcheon plate;
said wings held together around a pivot point that allows rotation of one wing with respect to the opposing wing.

19. The shower assembly of claim 18 further comprising:
a planar plate portion;
a planar edge; and
a semicircular notch extending between each of said planar edges on said wings.

20. The shower assembly of claim 19 further comprising:
an upturned circular edge on a first of said wings; and
a complementary aperture on a second of said wings.
